(19) United States
(12) Patent Application Publication
(10) Pub. No.: US 2014/0344868 A1
(43) Pub. Date: Nov. 20, 2014

(54) SWITCHING METHOD OF DIFFERENT DISPLAY WINDOWS OF A TV

(71) Applicants: Xijia Hu, Qingdao (CN); Yuanwu Zhou, Qingdao (CN); Junjie Huang, Qingdao (CN); Hui Wang, Qingdao (CN); Xiaona Zhang, Qingdao (CN); Fanfeng Meng, Qingdao (CN); Yanan Sun, Qingdao (CN)

(72) Inventors: Xijia Hu, Qingdao (CN); Yuanwu Zhou, Qingdao (CN); Junjie Huang, Qingdao (CN); Hui Wang, Qingdao (CN); Xiaona Zhang, Qingdao (CN); Fanfeng Meng, Qingdao (CN); Yanan Sun, Qingdao (CN)

(73) Assignee: Haier Group Co., Qingdao (CN)

(21) Appl. No.: 14/252,179

(22) Filed: Apr. 14, 2014

(30) Foreign Application Priority Data
May 20, 2013 (CN) CN201310187919.1

(51) Int. Cl. H04N 21/482

(52) U.S. Cl. CPC H04N 21/482
USPC 725/59

(57) ABSTRACT

The present invention provides a switching method of the different display windows of a TV. Before the switching, the TV displays the TV programs, received from the broadcast system and a server, in a main window and a sub-display window respectively, and the switching method includes the following steps that: the TV and the server determine the channel identifiers of the TV programs displayed by each other; the TV displays the TV programs, received from the broadcast system and the server, with the channel identifiers of each other using the first display window and the second display window respectively. By the present invention, the sources of the contents displayed respectively in the first display window and second display window do not change, thereby maintaining the respective display quality (including resolution and picture size) of the two display windows unchangeable before and after the switching.

### TECHNICAL FIELD

The present invention relates to a switching method of different display windows of a TV.

### BACKGROUND ART

Currently, most smart TVs support that multiple display windows display different contents (e.g. Picture In Picture (PIP) or Picture Out Picture (POP)) in their screens, when switching between a main display window and a sub-display window, the TV mainly has the following switching methods:

In the case that two different TV programs are received from the same program source (e.g. all parsed from the TV program stream of the broadcast system), before switching, the TV parses, from the received TV program streams, the TV programs of the corresponding channels displayed in the main display window and the sub-display window respectively, and displays the respective contents through the main display window and the sub-display window, when the switching is executed, the TV operates the two parsed contents displayed by the windows of each other. Currently, in the case that two different programs are received from different program sources, such as receiving the TV program stream from the broadcast system and also receiving the programs from the server of the Internet, before switching, the TV parses, from the received TV program signals, the program displayed in the main window, and receives, from the server, the program data displayed in the sub-display window, and then displays the respective contents through the main display window and the sub-display window. When the switching is executed, the TV controls the two content portions to be displayed using the windows of the other party.

The said switching process of the TV display windows is achieved by the TV device, and it does not need to make any change to the process of receiving signals. For example, the description of China patent application No. CN200880016617 publicizes that the display is capable of receiving one or more TV channels and an independent designated application channel and having at least a first display window and a second display window. The information sent by the designated application channel is displayed on the first display window while simultaneously one of the TV channels is displayed on the second display window, and the information received from the designated application channel is allowed to switch between the first display window and the second display window.

As the first display window and the second display window normally corresponds to the main display window with big size and the sub-display window with small size, and after switching, if the low resolution content displayed in the sub-display window originally is enlarged to be displayed in the main display window, the display quality will be reduced significantly as a result.

### SUMMARY

In view of this, the main aim of the present invention provides a switching method of different display windows of a TV to maintain the display quality of the respective display windows before and after the switching.

The present invention provides a switching method of different display windows of a TV, before the switching, the TV displays the TV programs, received from the broadcast system and the server, in the main window and the sub-display window respectively, and the switching method includes the following steps:

A. the TV and the server confirm the channel identifiers of the TV programs displayed by each other;

B. Using the first display window and the second display window respectively, the TV displays the TV programs, received from the broadcast system and the server, with the channel identifiers of each other.

According to the switching method above, the sources of the respective contents displayed in the first display window and the second display window respectively do not change before and after the switching, that is, the first display window still displays the TV program of the broadcast system and the second display window still displays the TV program sent by the server, but the specific displayed channels are switched. The switching, the sources of the respective contents displayed in the first and second display windows do not change, thereby maintains the same respective display quality (including resolution and picture size) of the two display windows unchangeable before and after the switching, and it is not like the prior art that the display quality is declined which is caused by that, after switching, the content with low resolution displayed in the sub-display window originally is enlarged to be displayed in the main display window.

Wherein, the step A includes that:

The TV sends the channel identifier of the TV program displayed in its first display window to the server;

The server returns the channel identifier of the TV program displayed in the second display window to the TV.

Due to the above, if the TV receives a switching order from a remote controller, by the information interaction with the server, the two parties could obtain the original displayed channel identifiers of each other, thus to accomplish the switching in the present invention.

Alternatively, it further includes that: the TV further sends the size and/or resolution information of the second display window to the server; and in the step B, the TV program received from the server is the TV program processed by the sever according to the size and/or resolution information of the second display window.

From the above, the server may further adjust or choose, according to the received parameters, such as the size and/or resolution information of the second display window of the TV, and so on, the TV program data with appropriate resolution to send to the TV, which is aimed to adapt to the display quality of the second display window of the TV.

Alternatively, before the step B, it further includes that:

if the TV has not received the TV program displayed in the second display window sent from the server, the TV program displayed in the second display window would be parsed from the TV program stream received from the broadcast system firstly and then to be displayed in the second display window.

Due to the above, because the communication between the TV and the server brings a certain time delay, so if the TV has not received the TV program sent from the server, the corresponding TV program would be parsed from the TV program stream received from the broadcast system firstly and be displayed by the second display window (the content required to be displayed in the first display window would be parsed and be displayed by the first display window simultaneously), thereby the time delay for displaying the content of the second display window can be shortened and the user experience will be better.

Alternatively, before the step B, it further includes that:

if the received and buffered data of the TV program displayed in the second display window sent from the server does not reach preset quantity, the TV program displayed in the second display window would be parsed from the TV program stream received from the broadcast system firstly to be displayed in the second display window.

Due to the above, because the TV displays the TV program data from the sever, and displaying such network TV program normally requires to buffer sufficient data firstly to avoid the interruption in the display process, so the time delay after switching is unavoidable, and by using the present step, it will shorten the time delay for displaying the content in the sub-display window.

Wherein, the first display window and second display window are the main display window and the sub-display window respectively.

Due to the above, the present invention can be applied to a scenario in which the display window size and the user attention of the main display window and the sub-display window are different.

Wherein, the TV program displayed in the second display window sent from the server includes a TV program preview clip.

Due to the above, the present invention can be applied to a scenario in which the second display window corresponding to the sub-display window can display the TV program preview clip.

Wherein, the TV program preview clip includes a clip of the video stream and/or the pictures.

Due to the above, in the scenario of previewing the TV program clip which is applied by the present invention, the second display window can merely display the clip of the video stream and/or the pictures, but not need to display the whole program completely.

### BRIEF DESCRIPTION OF THE DRAWING

FIG. 1 is the principle diagram of the switching method of the different display windows of a TV provided by the present invention.

### DETAILED DESCRIPTION OF PREFERRED EMBODIMENTS

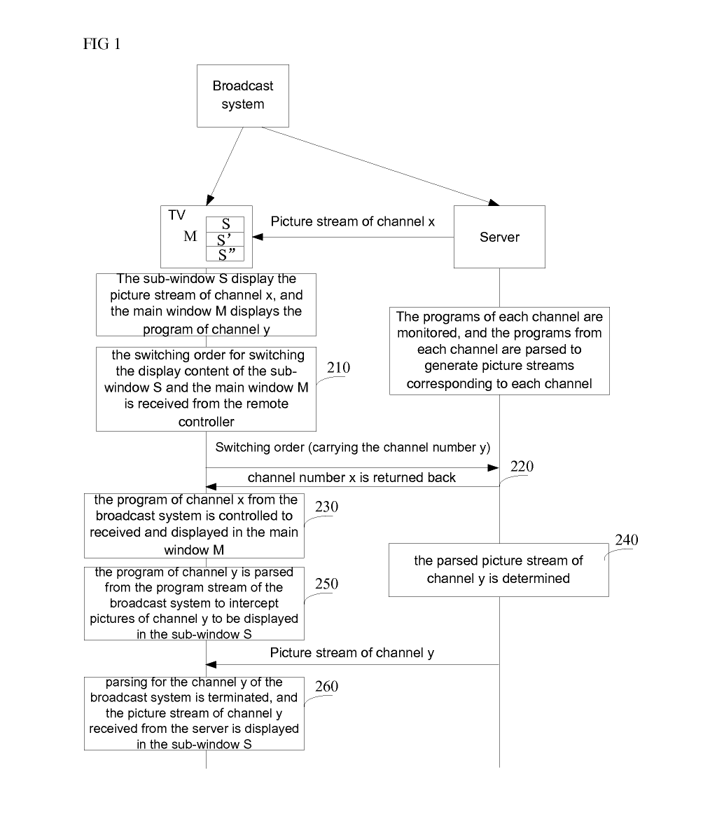

As the principle diagram shown in FIG. 1, the system applied by the present invention, includes a TV, a broadcast system and a server.

The broadcast system is used for broadcasting the TV program signals, and the TV normally uses a TV program signal receiver, such as a built-in tuner or an external set-top box, for receiving the TV programs.

The server connects with the TV via Internet, and the server further uses multiple TV program signal receivers (e.g. built-in or external TV capture card) for receiving the TV programs from the broadcast system to realize monitoring and parsing the TV program signals of each channel in the TV program streams broadcasted by the broadcast system, carrying out the corresponding data processing, such as intercepting the clips of the video stream or series of the picture stream, and then transmitting to the TV via the Internet. For convenience of description, the video stream and the picture stream are generally referred to as the multi-media stream in the following.

The TV includes the TV program signal receiver for receiving the TV program signals from the broadcast system, and further includes a network module (e.g. wired or wireless network card) for accessing to the Internet via the Internet access point to receive the TV program data of certain channel sent by the server. The TV can display the main display window and multiple sub-display windows for displaying the TV programs of the broadcast system and the data of each TV programs sent from the server.

For convenience of description, the TV programs sent from the broadcast system are referred as the TV programs, and the TV programs sent from the server are referred as the TV program preview clips, and the clips can be the clips of the video stream or be continued series of pictures intercepted from the video stream.

That above method can be applied for receiving, through the main display window, the TV program from the broadcast system to be viewed and receiving, through the sub-display window, the TV programs preview clips of other channels sent from the sever to preview the other channels. Applying the above structure, the processing of the other channels, such as tuning and decoding and so on, is mainly executed by the server, making full use of the high efficient running characteristic of the server, thus such system would be faster for executing the tuning and processing of every other channels simultaneously, and its screen would display more smoothly, even if multiple sub-display channels are opened to preview multiple channels, it also would be smooth relatively.

Referring to the diagram shown in FIG. 1, the switching method of the present invention will be described in detail in the following. Before the switching, it is supposed that channel number of the TV program displayed by the main screen M of the TV currently is y; the TV communicates with the internet server to obtain the TV program preview clip of the channel x sent from the server to be displayed by the sub-display window S of the TV, thereby facilitating users to preview the channel x.

When the user chooses the sub-display window S through the direction key of the remote controller and then presses the switching key, a switching order is issued by the remote controller, and the switching process includes the following steps:

Step 210, when receiving the switching order from the remote controller, the TV sends the switching order to the server, and the channel number y of the program displayed by the main display window of the TV is uploaded to the server through the switching order.

After the TV receives the switching order and judges that there is no record of the channel number of the displayed TV program preview clip corresponding to the sub-display window S (the server could apply the push approach to push the TV program preview clip to the TV, thus it is a possible case that the server does not push the channel number), the channel number of the TV program preview clip displayed by the sub-display window S would be requested together in the above said switching order.

Necessarily, the IP addresses of the server and the TV are further included in the switching order, and these are the commonly used communication methods of the TV and the server, and need not be repeated here. The parameters, such as the size or the resolution of the sub-display window S of the TV, and so on, could further be carried in the switching order in order to facilitate the server to complete corresponding video or image processing.

Step 220: after the switching order is received by the server, and if the channel number of the TV program preview clip displayed by the sub-display window S is requested in the switching order, the server will firstly returns the corresponding channel number y back to the TV via a responding message. This is because the channel number occupies very small data quantity, so it can be returned at once.

Step 230: the TV receives the channel number x returned back by the server in the step 220, or has stored the channel number x sent by the server before, then the TV parses the TV program of the channel x from the TV program of the broadcast system to be received by the TV and displayed in its main display window M.

Step 240: the server selects, from the data of each channel monitored by the server, the multi-media stream corresponding to the channel number y according to the channel number y in the switching order, and it further can adjust or select multi-media stream data with proper resolution according to the received parameters such as the size or resolution of the sub-display window S of the TV, and so on, to be sent to the TV.

Step 250: if the TV has not received the TV program preview clip of the channel y sent by the server, or the TV has not buffered sufficient data of the TV program preview clip (buffering sufficient data to avoid the intermission during the display process), the TV program of the channel y can be firstly parsed from the received TV program stream of the broadcast system (i.e. the TV program of the channel y is continuously be parsed simultaneously) and be displayed in the sub-display window S. The capability of the TV processing chip will be occupied by the step, but it will shorten the time delay for displaying the content of the sub-display window.

Step 260: if the TV receives the TV program preview clip of the channel y sent by the server, parsing program stream of channel y from the received TV program of the broadcast system is terminated. The received TV program preview clip sent from the server is displayed in the sub-display window S.

Due to the above, after the switching is accomplished, in such switching method of which the programming channel x displayed in the main display window M of the TV is originated from the broadcast system, and the information of the channel y displayed in the sub-display channel S is originated from the server, because the TV program in the main display window is still originated from the broadcast system, so the TV can fully apply the capability of its decoding chip to smoothly parse and display the program of the main display window, while the program displayed in the sub-display window S is still originated from the server, thus the flexibility advantage of displaying content by the sub-display window still can be fully applied (for example, inserting advertisement content in the picture, etc.), although there is certain signal hysteresis in the sub-display window, as it is the sub-display window, the user's overall effect of watch does not be affected (because the user mainly pays attention to the content displayed in the main display window).

The above said is only a better embodiment of the present invention, and it is not used to limit the present invention, for example, the channel number above is also can be replaced by the channel description to identify the channel uniquely, and they can be referred as channel identifier as a general term. Any modification, equivalent replacement, improvement and so on, made within the spirit and principle of the present invention should all be fallen into the protection scope of the present invention.

What is claimed is:

1. A switching method of different display windows of a TV, the TV displays the TV programs, received from a broadcast system and a server, in a main window and a sub-display window respectively before switching, comprising the following steps that:
A. the TV and the server confirm the channel identifiers of the TV programs displayed by each other;
B. Using the first display window and the second display window respectively, the TV displays the TV programs, received from the broadcast system and the server, with the channel identifiers of each other.

2. The method according to claim 1, wherein the step A includes that:
the TV sends the channel identifier of the TV program displayed in its first display window to the server;
the server returns the channel identifier of the TV program displayed in the second display window to the TV.

3. The method according to claim 2, wherein it further includes that: the TV further sends the size and/or resolution information of the second display window to the server;
and in the step B, the TV program received from the server is the TV program processed by the sever according to the size and/or resolution information of the second display window.

4. The method according to claim 1, wherein, before the step B, it further includes that:
if the TV has not received the TV program displayed in the second display window sent from the server, the TV program displayed in the second display window will be parsed from the TV program stream received from the broadcast system firstly and then to be displayed in the second display window.

5. The method according to claim 1, wherein, before the step B, it further includes that:
if the received and buffered data of the TV program displayed in the second display window sent from the server does not reach preset quantity, the TV program displayed in the second display window would be parsed from the TV program stream received from the broadcast system firstly to be displayed in the second display window.

6. The method according to claim 1, wherein the first display window and second display window are the main display window and the sub-display window respectively.

7. The method according to claim 1, wherein the TV program displayed in the second display window sent from the server includes a TV program preview clip.

8. The method according to claim 7, wherein the TV program preview clip includes a clip of video stream and/or pictures.
